(19) United States
(12) Patent Application Publication
(10) Pub. No.: US 2018/0292979 A1
(43) Pub. Date: Oct. 11, 2018

(54) CONTROL APPARATUS AND NON-TRANSITORY COMPUTER READABLE MEDIUM

(71) Applicant: FUJI XEROX CO., LTD., Tokyo (JP)

(72) Inventor: Takao MAEKAWA, Kanagawa (JP)

(73) Assignee: FUJI XEROX CO., LTD., Tokyo (JP)

(21) Appl. No.: 15/807,278

(22) Filed: Nov. 8, 2017

(30) Foreign Application Priority Data
Apr. 11, 2017 (JP) 2017-078239

(51) Int. Cl. G06F 3/0484

(52) U.S. Cl. CPC G06F 3/04842; G06F 3/0482; G06F 3/04845; G06F 3/04847

(57) ABSTRACT

A control apparatus includes a display unit that causes a display to present a screen having an operator displayed thereon, a receiving unit that receives an operation performed on the operator, and a controller that controls the receiving unit such that when a first operator and a second operator are displayed with at least part of the first operator covered with part of the second operator, an operation performed on a first region is not received for a predetermined period of time. The first region is at least part of an area where the first operator and the second operator overlap each other.

### CROSS-REFERENCE TO RELATED APPLICATIONS

This application is based on and claims priority under 35 USC 119 from Japanese Patent Application No. 2017-078239 filed Apr. 11, 2017.

### BACKGROUND

### (i) Technical Field

The present invention relates to a control apparatus and a non-transitory computer readable medium.

### (ii) Related Art

Graphical user interfaces (GUIs) that receive an operation performed on a virtual operator displayed on a display have been disclosed. The operation is performed onto the operator using a pointing device, such as a touchpanel or mouse. There is a possibility that two operators overlap each other. More specifically, a first operator and a second operator may be displayed with the second operator covering a screen containing the first operator. Also, screen transition may be performed shifting from a screen containing the first operator to a screen containing the second operator.

When the first and second operators are displayed with at least part of the first operator covered with part of the second operator, the second operator may contain an area that does not overlap the first operator. A user may now intend to operate the second operator. For the user not to erroneously operate the first operator instead of the second operator, the user may operate an area of the second operator that does not overlap the first operator.

### SUMMARY

According to an aspect of the invention, there is provided a control apparatus. The control apparatus includes a display unit that causes a display to present a screen having an operator displayed thereon, a receiving unit that receives an operation performed on the operator, and a controller that controls the receiving unit such that when a first operator and a second operator are displayed with at least part of the first operator covered with part of the second operator, an operation performed on a first region is not received for a predetermined period of time. The first region is at least part of an area where the first operator and the second operator overlap each other.

### BRIEF DESCRIPTION OF THE DRAWINGS

Exemplary embodiment of the present invention will be described in detail based on the following figures, wherein:

FIG. 1 illustrates a hardware configuration of a control apparatus;

FIG. 2A through FIG. 2D illustrate an example of GUI that is to be controlled by the control apparatus;

FIG. 3 illustrates a functional configuration of the control apparatus;

FIG. 4 is a flowchart of a display control process;

FIG. 5A through FIG. 5D illustrate display examples of operators; and

FIG. 6A through FIG. 6C illustrate locations where operations have been received.

### DETAILED DESCRIPTION

An exemplary embodiment of the present invention is described below. The exemplary embodiment is related to a technique of controlling a graphic user interface (GUI) that operates an electronic apparatus. The exemplary embodiment may be used in any type of electronic apparatus. For example, the exemplary embodiment may be used in an image forming apparatus, such as a copying machine. A control apparatus of the exemplary embodiment may be included in the electronic apparatus, or an information processing apparatus that sends a command to the electronic apparatus. The GUI may be presented on a display having a touchpanel, or may be presented on a display included in the image processing apparatus that may be operated using a keyboard and/or a mouse.

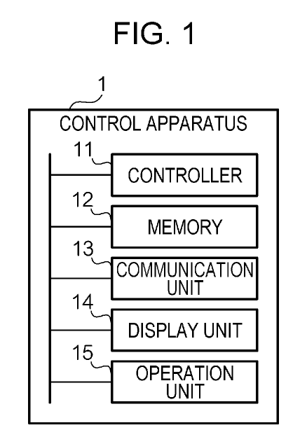

FIG. 1 illustrates a hardware configuration of a control apparatus 1. The control apparatus 1 includes a controller 11, a memory 12, a communication unit 13, a display unit 14, and an operation unit 15. The memory 12 may be a hard disk drive or a memory, and stores a program and data. The controller 11 includes a processor and a memory that is used as a working area for an arithmetic operation, and performs a process controlled by the program stored on the memory 12. The communication unit 13 is a communication interface that interfaces the control apparatus 1 with an external apparatus. The communication unit 13 may include an interface for a local-area network (LAN) or a modem.

The display unit 14 includes a liquid-crystal display panel, for example, and presents a GUI screen having a widget that operates the electronic apparatus. The operation unit 15 includes a pointing device, and receives an operation performed on the GUI. The pointing device may be a mouse, a touchpad or a touchpanel that covers the display screen of the display unit 14. The display unit 14 and the operation unit 15 may be configured to be a device separate from the control apparatus 1.

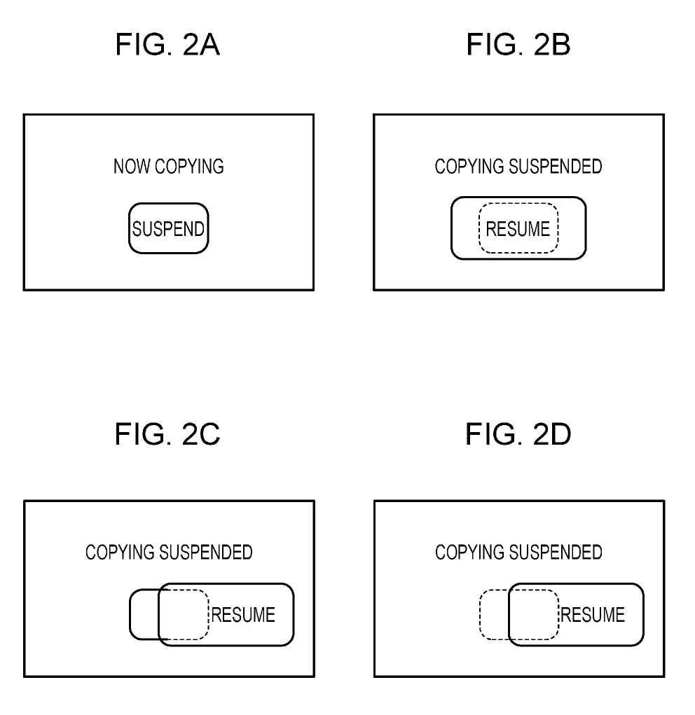

FIG. 2A through FIG. 2D illustrate examples of the GUI that is to be controlled by the control apparatus 1. Referring to FIG. 2A through FIG. 2D, an operation to suspend copying and an operation to resume the copying that has been suspended are performed on the GUI to operate the copying machine. FIG. 2A illustrates a screen while copying is in progress. If a suspend button (an example of a first controller) is operated on the screen, the copying is suspended. FIG. 2B illustrates a screen example that is presented when the copying is suspended. In this example, the entire suspend button is covered with part of a resume button (an example of a second operator). When the resume button is operated, the copying resumes and the GUI reverts back to the screen of FIG. 2A. The outline of the resume button is illustrated with a broken line. In an actual screen, the suspend button may be designed to be seen through, or only the resume button may be displayed. However, even if the suspend button is seen through, the suspend button is disabled. The copying machine may be suspended in operation because of paper jamming or being out of paper or toner. In such a case, the resume button is displayed without operating the suspend button. In other word, the second operator is displayed in response to or regardless of an operation to the first operator.

FIG. 2C illustrates another example of the screen presented when the copying is suspended. In this example, part of the suspend button is covered with part of the resume button. Note that the outline of part of the suspend button where the resume button overlaps the suspend button is indicated by a broken line. In the actual screen, the suspend button may be seen through or only the resume button may be displayed. Even if the suspend button is seen through, the suspend button is disabled in operation. Also in an area of the resume button where the resume button does not overlap the suspend button, the suspend button is disabled in operation.

FIG. 2D illustrates another screen displayed when the copying is suspended. On this screen, the resume button is displayed at the same location as in the example of FIG. 2C, but the suspend button is not displayed.

In each of the examples of FIG. 2B, FIG. 2C, and FIG. 2D, the suspend button and resume button are displayed in a manner such that at least part of the suspend button is covered with part of the resume button. In those screens, the following erroneous operations may be possibly performed. For example, a user presses the resume button, but a response from the apparatus may be slower than the user has expected. The user may then attempt to press the resume button again. In response to the first operation to the resume button, the resume button is deleted and the suspend button is displayed. The user may erroneously press the suspend button. In another example, if the user repeatedly presses on a location in the resume button in a hurry, the first operation to the resume button deletes the resume button, and the suspend button is displayed. The user thus erroneously presses the suspend button. In another example, if the copying is suspended because the copying machine is running out of paper, the user may attempt to press the resume button after replenishing recording paper sheets. In such a case, the replenishing of the recording paper causes the copying machine to automatically resume copying, the suspend button is displayed, and the user then erroneously presses the suspend button. If the first and second operators are displayed with at least part of the first operator covered with part of the second operator, the user may erroneously press the first operator even through the user does not intend to do so. Conversely, the user may erroneously press the second operator even though the user intends to press the first operator. In another example, the suspend button may now be displayed, and even if the user presses the suspend button, there may be no response for some reason. If the user repeatedly presses the suspend button, the resume button is suddenly displayed covering the suspend button, and the user erroneously presses the resume button.

A program that describes a procedure of a display control process is installed on the control apparatus 1. The controller 11 executes the program to perform each function of the control apparatus 1. The control apparatus 1 thus performs the display control process.

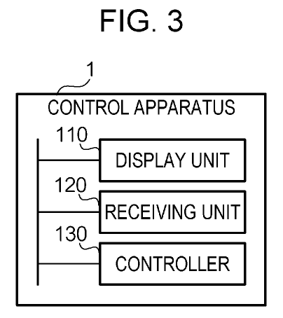

FIG. 3 illustrates a functional configuration of the control apparatus 1. A display unit 110 causes a display apparatus to present a screen where operators are displayed. A receiving unit 120 receives operations performed on the operators. When at least part of the first operator is covered with part of the second operator, a controller 130 controls the receiving unit 120 for a predetermined period of time such that no operation is received on a first region that is part of an area where the first and second operators overlap.

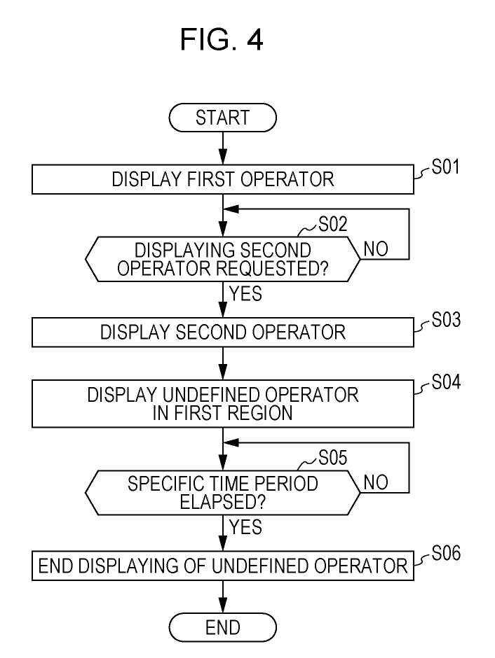

FIG. 4 is a flowchart of the display control process. If a predetermined condition is satisfied, the controller 11 starts the display control process. More specifically, the controller 11 starts the display control process when an electronic apparatus starts a predetermined process (for example, the copying machine starts copying) or the electronic apparatus shifts from a predetermined state to another state (for example, the copying machines resumes the copying).

The controller 11 causes the first operator to be displayed (step S01). More specifically, the controller 11 causes to be displayed an operator that matches contents of the process to be performed by the electronic apparatus. For example, the controller 11 causes the suspend button (an example of the first operator) to be displayed when the copying starts or resumes.

The controller 11 determines the presence or absence of a request to display the second operator. If no display request has been issued (no branch from step S02), the same determination is repeated. If a display request has been issued (yes branch from step S02), the controller 11 causes the second operator to be displayed (step S03). For example, if the suspend button (an example of the first operator) is operated, the controller 11 determines that the request to display the resume button (an example of the second operator) has been issued.

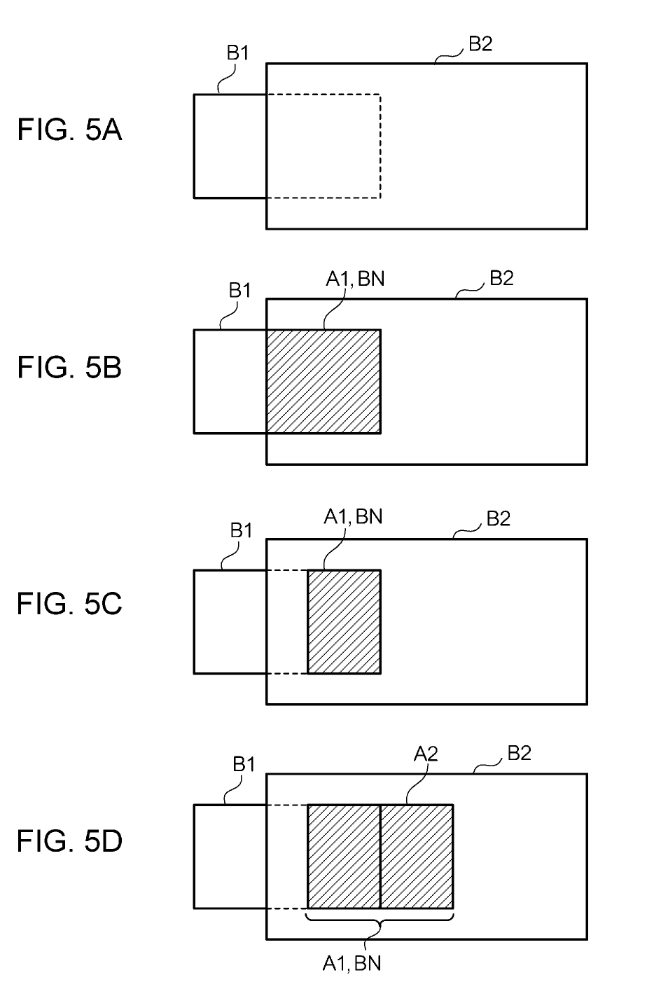

FIG. 5A through FIG. 5D illustrate display examples of operators. FIG. 5A illustrates a positional relationship between a first operator B1 and a second operator B2. As in the example of FIG. 2C, part of the first operator B1 is covered with part of the second operator B2. The process described below is performed when the whole first operator B1 is covered with part of the second operator B2 as illustrated in FIG. 2B. The process described below is also performed when the second operator B2 is displayed though the first operator B1 is not displayed in practice with part of the first operator B1 covered with part of the second operator B2 as illustrated in FIG. 2D.

The controller 11 causes an undefined operator BN on a first region A1 (step S04). The first region A1 is at least part of an area where the first and second operators B1 and B2 overlap each other, and is unable to receive an operation thereon. In accordance with the exemplary embodiment, the first region A1 is predetermined. The undefined operator BN has an operation whose process that is to be performed in response to the operation is not defined. Even if the user operates the undefined operator BN, the controller 11 does not perform any process. With the undefined operator BN displayed, the first region A1 is set up on the screen. If an operation is performed on an area of the second operator B2 that is not contained in the first region A1, the controller 11 performs a process responsive to the second operator B2. The undefined operator BN may be different in appearance from the first and second operators B1 and B2, an outline of the area where the first and second operators B1 and B2 overlap each other may be represented by a line, and the undefined operator BN may be a clear transparent operator.

FIG. 5B illustrates an example of the first region A1. In this example, the whole area where the first and second operators B1 and B2 overlap each other is set up as the first region A1. FIG. 5C illustrates another example of the first region A1. In this example, part of the area where the first and second operators B1 and B2 overlap each other is defined as the first region A1.

The controller 11 determines whether a specific time period has elapsed. If the specific time period has not elapsed (no branch from step S05), step S05 is repeated. If the specific time period has elapsed (yes branch from step S05), the controller 11 ends the displaying of the undefined operator (step S06). The specific time period is a predetermined time length from the start of the displaying of the second operator B2. When the displaying of the undefined operator ends, the setting of the first region A1 is canceled. When an operation is performed on the first region A1 in the second operator B2, the controller 11 performs a process responsive to the second operator B2.

Since with this configuration, an operation performed on at least part of the area where the first and second operators B1 and B2 overlap each other is not received for a predetermined period of time, the possibility of an erroneous operation on the first operator B1 is reduced. An operation performed on the second operator B2 not containing the first region A1 is received during the predetermined period of time.

The user typically tends to avoid pressing an edge portion of each operator in view of the possibility of an erroneous operation. The edge portion of the second operator B2 is not contained in the first region A1 (see FIG. 5C). However, since the edge portion of the second operator B2 is not entirely free from being pressed, the edge portion of the second operator B2 may be contained in the first region A1 (see FIG. 5B).

### Modifications

The exemplary embodiment may be modified as described below.

### First Modification

In a first modification, the controller 130 may control the receiving unit 120 such that an operation performed on the first region A1 containing a second region A2 is not received. The second region A2 is part of an area where the first and second operators B1 and B2 do not overlap each other.

FIG. 5D illustrates a setting example of the second region A2. The second region A2 is part of the area of the second operator B2 that does not overlap the first operator B1. More specifically, the first region A1 contains at least part (the first region A1 described with reference to the exemplary embodiment) of the area where the first and second operators B1 and B2 overlap each other and part (the second region A2) of the area of the second operator B2 that does not overlap the first operator B1. In contrast to the exemplary embodiment, this configuration guides the user into operating the second operator B2 in a location apart from the first operator B1. The first modification reduces the possibility of erroneous operation on the first operator B1 compared to the exemplary embodiment.

### Second Modification

In a second modification, the controller 130 may set the first region A1, based on history of locations on the screen on which the receiving unit 120 has received operations.

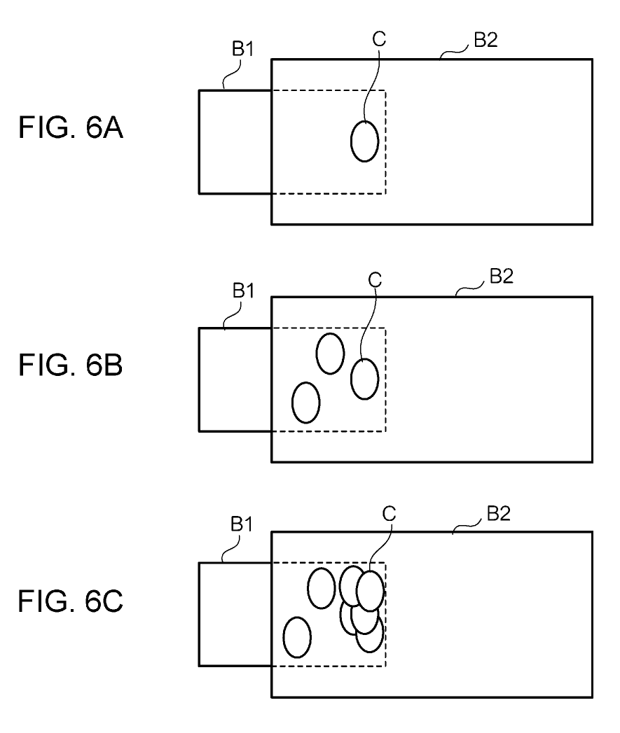

FIG. 6A through FIG. 6D illustrate locations where operations have been received. FIG. 6A through FIG. 6D illustrate elliptical regions C where a user's finger touches with a touchpanel mounted as a pointing device. The first region A1 may be set up based on a single location included in the history. The single location may be the latest location. If the first region A1 is set up at the location of FIG. 6A, the first region A1 may appear as illustrated in FIG. 5B.

### Third Modification

In a third modification, the first region A1 may be set up at plural locations included in the history. If the first region A1 is set up in accordance with plural locations of FIG. 6B, the first region A1 appears as illustrated in FIG. 5B. The plural locations included in the history may be plural locations on which operations have been performed for a predetermined period of time, or may be locations randomly extracted from the history. Alternatively, the first region A1 may be set up based on a value into which the plural locations included in the history are statistically processed (such as a mode value or a median value). As illustrated in FIG. 6C, more operations are performed on the right side of the area where the first and second operators B1 and B2 overlap each other. If the first region A1 is set up based on the mode value, the first region A1 appears as illustrated in FIG. 5C.

### Fourth Modification

In a fourth modification, the controller 130 may receive a command to delete an operation after the operation is received on an area of the second operator B2 that does not overlap the first operator B1. In such a case, the second region A2 may be set up to contain the location where the operation has been received. For example, an operation may be performed on the area of the second operator B2 that does not overlap the first operator B1. The user who may be alerted to the possibility that the first operator B1 has been erroneously operated may cancel that operation, and perform an operation at a location apart from the first operator B1. The fourth modification includes the case in which a second region is newly set up in the undefined screen, and the case in which the second region that has been set up is expanded.

### Fifth Modification

In a fifth modification, the controller 130 may set up the first region having a size that varies depending on the area where an object is in contact with the screen, or on the type of a pointing device. For example, a touchpanel used for the pointing device may be operated by using a human's finger or a stylus. Since the contact area with the screen is larger when the finger is used than when the stylus is used, the possibility of erroneous operation is higher when the touchpanel is operated using the finger. The area of the first region may be set to be larger as the area of an object in contact with the screen increases. When the area of the first region is set, the contact area with the touchpanel is stored each time the operation is performed, a statistical value of the contact areas of the operations heretofore performed (a mean value, a maximum value, or a medium value) is determined when the number of operations has reached a predetermined count. The first region may be set up using the statistical value. The touchpanel or mouse may be used for the pointing device. The area where the finger or stylus is contact with the touchpanel is larger than the area indicated by a point pointed to by a cursor (pointer) of the mouse. The use of the touchpanel has a higher possibility of erroneous operation. The first region is set to have a larger area when the touchpanel is used for the pointing device than when the mouse is used.

### Sixth Modification

In a sixth modification, the receiving unit 120 may receive an operation to set the first region. For example, an area where the user has actually experienced an erroneous operation or an area having a possibility that the user performs an erroneous operation may be set up as the first region.

### Seventh Modification

In a seventh modification, the controller 130 may set to be an end time of a predetermined period of time a time point when an operation is received on a third operator displayed or when an operation is received on a hardware key. In the seventh modification, the user ends the time period throughout which no operation is received in the first region. The first region that is unable to receive an operation means a decrease in working efficiency to a user who is confident of being free from erroneous operations. In the seventh modification, the decrease in working efficiency is controlled.

### Eighth Modification

A program causing a computer to perform the process may be distributed in a stored form on a computer readable recording medium, such as an optical recording medium and/or a semiconductor memory, or may be distributed via a communication network, such as the Internet. If the program of the exemplary embodiment is distributed in a form continuously stored form on a recording medium, the computer reads the program from the recording medium. If the program of the exemplary embodiment is distributed via the communication network, the computer uses the program by receiving the program from an apparatus serving as a delivering source.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control apparatus comprising:
a display unit that causes a display to present a screen having an operator displayed thereon;
a receiving unit that receives an operation performed on the operator; and
a controller that controls the receiving unit such that when a first operator and a second operator are displayed with at least part of the first operator covered with part of the second operator, an operation performed on a first region is not received for a predetermined period of time, wherein the first region is at least part of an area where the first operator and the second operator overlap each other.

2. The control apparatus according to claim 1, wherein the controller controls the receiving unit such that an operation performed on the first region containing a second region is not received, wherein the second region is part of an area of the second operator where the second operator does not overlap the first operator.

3. The control apparatus according to claim 1, wherein the controller sets up the first region, based on history of a location on the screen where the receiving unit has received an operation.

4. The control apparatus according to claim 2, wherein the controller sets up the first region, based on history of a location on the screen where the receiving unit has received an operation.

5. The control apparatus according to claim 3, wherein the controller sets up the first region, based on a plurality of locations included in the history.

6. The control apparatus according to claim 4, wherein the controller sets the first region, based on a plurality of locations included in the history.

7. The control apparatus according to claim 2, wherein when a command to delete an operation is received after the operation has been received in an area of the second operator where the second operator does not overlap the first operator, the controller sets up the second region such that the second region contains a location that has received the operation.

8. The control apparatus according to claim 3, wherein the controller sets up the first region having a size that varies depending on an area where an object is in contact with the screen or on a type of a pointing device.

9. The control apparatus according to claim 4, wherein the controller sets up the first region having a size that varies depending on an area where an object is in contact with the screen or on a type of a pointing device.

10. The control apparatus according to claim 5, wherein the controller sets up the first region having a size that varies depending on an area where an object is in contact with the screen or on a type of a pointing device.

11. The control apparatus according to claim 6, wherein the controller sets up the first region having a size that varies depending on an area where an object is in contact with the screen or on a type of a pointing device.

12. The control apparatus according to claim 7, wherein the controller sets up the first region having a size that varies depending on an area where an object is in contact with the screen or on a type of a pointing device.

13. The control apparatus according to claim 1, wherein the receiving unit receives an operation that sets up the first region.

14. The control apparatus according to claim 2, wherein the receiving unit receives an operation that sets up the first region.

15. The control apparatus according to claim 1, wherein the controller sets, to be a start time of a predetermined period of time, a start time to start displaying the second operator.

16. The control apparatus according to claim 2, wherein the controller sets, to be a start time of a predetermined period of time, a start time to start displaying the second operator.

17. The control apparatus according to claim 1, wherein the controller sets, to be an end time of a predetermined period of time, a time at which an operation on a displayed third operator or an operation on a hardware key has been received.

18. The control apparatus according to claim 1, wherein the controller sets up the first region by displaying an operator receiving an operation with a process thereof not defined.

19. The control apparatus according to claim 18, wherein the controller cancels setting of the first region by ending the displaying of the operator receiving the operation with the process thereof not defined.

20. A non-transitory computer readable medium storing a program causing a computer to execute a process for controlling, the process comprising:
causing a display to present a screen having an operator displayed thereon;
receiving an operation performed on the operator; and
performing control such that when a first operator and a second operator are displayed with at least part of the first operator covered with part of the second operator, an operation performed on a first region is not received for a predetermined period of time, wherein the first region is at least part of an area where the first operator and the second operator overlap each other.
